(19) United States
(12) Patent Application Publication
(10) Pub. No.: US 2010/0319654 A1
(43) Pub. Date: Dec. 23, 2010

(54) ROTARY VANE ENGINES AND METHODS

(76) Inventor: Hans-Peter MESSMER, Vienna (AT)

Correspondence Address: SNR DENTON US LLP, P.O. BOX 061080, CHICAGO, IL, 60606-1080, US

(21) Appl. No.: 12/815,937

(22) Filed: Jun. 15, 2010

Related U.S. Application Data
(60) Provisional application No. 61/187,866, filed on Jun. 17, 2009.

(51) Int. Cl. F02B 53/00; B23K 3/00

(52) U.S. Cl. 123/243; 29/888.012

(57) ABSTRACT

A rotary vane engine includes a sealing area that prevents or reduces carry-back between portions of the rotary vane engine. The rotary vane engine includes a stator housing having a stator wall with a first portion and a second portion. The first portion may be formed with a curvature that substantially matches the curvature of a rotor and provides the sealing. The rotary vane engine may include a first insert member for allowing adjustment of a fluid manipulation ratio (compression or expansion).

### RELATED APPLICATION

The present invention claims the benefit, under 35 USC §119(e), of the filing of U.S. Provisional Patent Application Ser. No. 61/187,866, entitled “Rotary Vane Engines and Methods,” filed Jun. 17, 2009, which is incorporated herein by reference for all purposes.

### BACKGROUND

The present disclosure relates generally to rotary vane engines, and more particularly, to improved rotary vane engines and methods.

Rotary vane engines have been in existence for a long time. Today, these engines are used in many applications, such as air power tools, air compressors, vacuum pumps, first stage evacuation pumps in laboratories, etc. At the same time, rotary vane engines have not met with wider application because existing rotary vane engines have relatively low efficiency.

### BRIEF SUMMARY

Shortcomings with aspects of conventional rotary vane engines are addressed by the variety of illustrative, non-limiting embodiments herein. According to one illustrative, non-limiting embodiment, a rotary vane engine includes a stator housing, which has a stator wall that defines an interior space, and a rotor having a curvature. The rotor is disposed within the interior space. The rotor has a plurality of slideable vanes operable to contact the stator wall. The stator wall has a first portion and a second portion. The first portion has a curvature that substantially matches the curvature of the rotor to form a sealing area between the rotor and stator housing and having a sealing distance (d) in cross section.

According to another illustrative, non-limiting embodiment, a rotary vane engine includes a stator housing having a stator wall, which defines an interior space, and a rotor having a curvature. The rotor is disposed within the interior space. The rotor has a plurality of slideable vanes that are operable to contact the stator wall to form a plurality of cells. The rotary vane engine further includes a first insert member disposed within the interior space and operable to adjust a fluid manipulation ratio of the rotary vane engine.

According to another illustrative, non-limiting embodiment, a rotary vane engine includes a stator housing, which has a stator wall that defines an interior space, and a rotor having a curvature. The rotor is disposed within the interior space. The rotor has a plurality of slideable vanes that are operable to contact the stator wall to form a plurality of cells. The stator wall of the stator housing has a first portion and a second portion. The first portion has a curvature that substantially matches the curvature of the rotor to form a sealing area between the rotor and stator housing having a sealing distance (d). The rotary vane engine may further include a first insert member disposed within the interior space and operable to adjust a fluid manipulation ratio of the rotary vane engine.

According to another illustrative, non-limiting embodiment, a method of manufacturing a rotary vane engine includes the steps of forming a stator housing having a stator wall and forming a rotor having a curvature. The stator wall defines an interior space. The method further includes disposing the rotor within the interior space. The rotor has a plurality of slideable vanes operable to contact the stator wall. The stator wall of the stator housing has a first portion and a second portion. The step of forming the stator housing includes forming the stator wall with a first portion that has a curvature that substantially matches the curvature of the rotor to form a sealing area between the rotor and stator housing with a sealing distance (d).

According to another illustrative, non-limiting embodiment, a method of manufacturing a rotary vane engine includes forming a stator housing having a stator wall and forming a rotor having a curvature. The stator wall defines an interior space. The method includes disposing the rotor within the interior space. The rotor is formed with a plurality of slideable vanes operable to contact the stator wall to form a plurality of cells. The method further includes forming a first insert member and disposing the first insert member within the interior space. The first insert member is operable to adjust a fluid manipulation ratio of the rotary vane engine.

According to another illustrative, non-limiting embodiment, a method of manufacturing a rotary vane engine includes the steps of forming a stator housing having a stator wall and forming a rotor having a curvature. The stator wall defines an interior space. The method further includes forming a rotor having a curvature and disposing the rotor within the interior space. The rotor has a plurality of slideable vanes operable to contact the stator wall to form a plurality of cells. The stator wall of the stator housing has a first portion and a second portion. The step of forming the stator housing includes forming the stator wall with the first portion having a curvature that substantially matches the curvature of the rotor so that in use a sealing area is formed between the rotor and stator housing. The method also includes forming a first insert member and disposing the first insert member within the interior space. The first insert member is operable to adjust a fluid manipulation ratio of the rotary vane engine.

Other features and advantages of the illustrative, non-limiting embodiments will become apparent with reference to the drawings and the detailed description that follow.

### BRIEF DESCRIPTION OF THE DRAWINGS

FIG. 1 is a schematic, perspective view of an illustrative rotary vane engine;

FIG. 2 is a schematic, perspective view of a portion of the rotary vane engine of FIG. 1 shown with a portion of the stator housing removed and the first insert member removed;

FIG. 3 is a schematic, cross-section of the rotary vane engine of FIG. 1 with the first insert member removed and having fewer slideable vanes;

FIG. 4 is a schematic cross-section of a portion of the rotary vane engine of FIG. 1;

FIG. 5 is a schematic cross-section of the rotary vane engine of FIG. 1 but with fewer slideable vanes;

FIG. 6 is a schematic, perspective view of the first insert member of FIG. 5;

FIG. 7 is a schematic, cross-section of another illustrative rotary vane engine that includes a first insert member;

FIG. 8 is a schematic, cross-section of the first insert member of FIG. 7; and

FIG. 9 is a schematic, cross-section of another illustrative rotary vane engine.

### DETAILED DESCRIPTION

In the following detailed description of the preferred embodiments, reference is made to the accompanying drawings that form a part hereof, and in which is shown, by way of illustration, specific embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

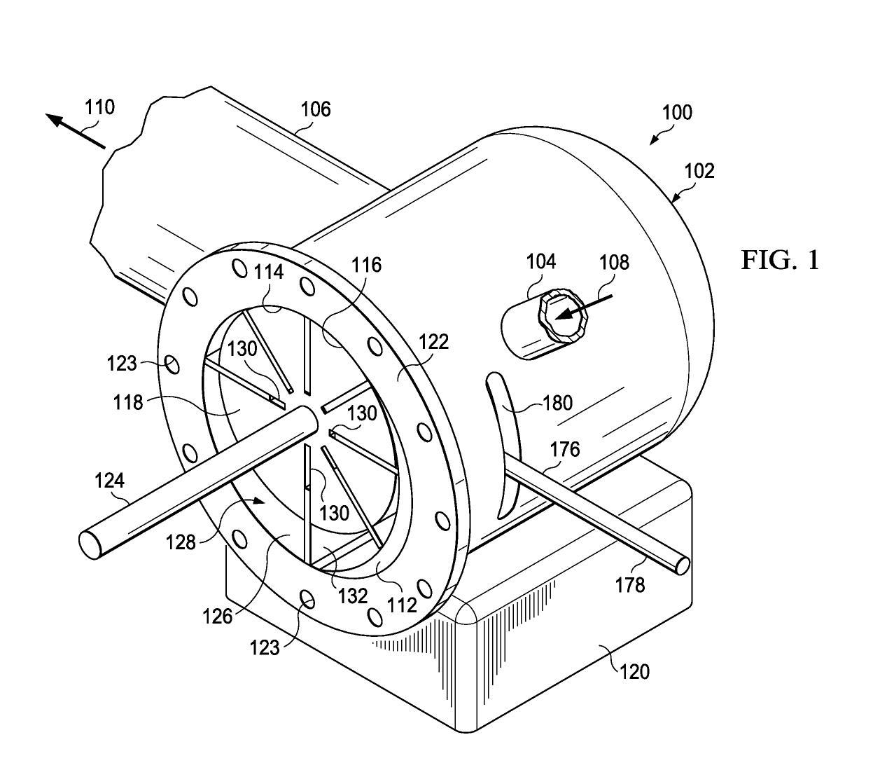

Referring now primarily to FIGS. 1-4, an illustrative, non-limiting embodiment of a rotary vane engine 100 is presented. The rotary vane engine 100 has a stator housing 102, or casing, that has a first port 104 and a second port 106. Depending on the desired mode of operation of the rotary vane engine 100, e.g., compression or expansion, the first port 104 serves as either an inlet or an outlet and likewise the second port 106 may serve as an inlet or outlet. In the illustrative, non-limiting embodiment presented, the rotary vane engine 100 is shown as an expansion engine and the first port 104 functions as an inlet for an inlet fluid 108 and the second port 106 functions as an outlet for an outlet fluid 110.

The inlet fluid 108 is a medium or working fluid, which is often air or another gas. Unless otherwise indicated, as used herein, “or” does not require mutual exclusivity. In one illustrative, the working fluid may be a liquid or a liquid/vapor mixture, i.e., a two-phase mixture. The rotary vane engine 100 receives the working fluid from the first port 104, expands the working fluid, and delivers the working fluid to the second port 106. Alternatively, the rotary vane engine 100 may receive a fluid through second port 106, compress the fluid, and exhaust the fluid through the first port 104. The rotary vane engine 100 may include a first insert member 112, and a substantial seal may be formed between a first portion 116 of stator housing 102 and the rotor 118 over a sealing distance (d) 114. The rotor 118 may be eccentrically mounted in the stator housing 102.

In the shown embodiment, the sealing distance 114(d) represents an area of a substantial seal between the first port 104 and second port 106 as will be described further below. As such, the rotary vane engine 100 is able to avoid carry-back, blow-by or leakage, between portions of the rotary vane engine 100. In conventional rotary vane engines, the rotor typically approaches the stator housing at one point in a cross section. Thus, a conventional rotary vane engine has only one, narrow tangential line of sealing to provide a seal, and consequently has issues with carry-back or leakage. By producing a sealing area over the sealing distance (d) 114, the rotary vane engine 100 is able to increase efficiency by avoiding carry-back or leakage.

The use of the first insert member 112 within the stator housing 102 allows the expansion/compression ratio to be adjusted. As used herein, “fluid manipulation ratio” designates either a compression or expansion ratio depending on the mode of operation of the rotary vane engine 100. In a conventional rotary vane engine, the fluid manipulation is set by the geometric constants for a particular engine such as the ratio of the rotor radius, number of vanes, and stator housing radius. In contrast, the rotary vane engine 100 of FIG. 1 may have the fluid manipulation ratio modified by use of the first insert member 112. In the illustrative, non-limiting embodiment shown, the first insert member 112 may be moved in real time to modify the fluid manipulation characteristics or fluid manipulation ratio. In an alternative embodiment, the first insert member 112 may be fixed or may be formed as part of the stator housing 102 as will be described further below.

In addition, the first insert member 112 allows “dead volume,” or “dead space” within the stator housing 102 to be avoided. This helps improve efficiency over conventional rotary vane engines. When operating as an expansion engine, the dead space is the volume in the interior space 128 that already exists when the working fluid enters the interior space 128 of the rotary vane engine 100. Some of the pressurized working fluid to be expanded enters the pre-existing space, or dead space, without producing any power. If the rotary vane engine 100 is operating as a compressor, the dead space is the volume of the interior space 128 which cannot be expelled from the interior space 128 after compression has been completed. The dead space may mean, at least in some rotary vane engines, that the remaining fluid is transferred to the low pressure side thereby lowering efficiency.

The avoidance of dead space increases efficiency, especially with a working fluid that is saturated steam being expanded. If dead space exists, a throttling process takes place and tends to derogate efficiency. By using the first insert member 112 with the substantial seal provided by creation of the sealing distance 114, the dead space and leakage can be avoided and efficiency improved. Moreover, non-isentropic throttling effects may be avoided or minimized. In addition, use of the first insert member 112, means that in commercial applications, the basic elements of the rotary vane engine 100 may be mass-produced and then varying dimensions and characteristics of the first insert member 112 may be made on this one part to achieve a wide range of characteristics for various applications. This enhances the economics of manufacturing.

Referring now primarily to FIG. 1, the rotary vane engine 100 is shown mounted on a mount stand 120 for presentation. An end member has been removed exposing a flange 122. The flange 122, which may have apertures 123, is used to align and attach the end member, but the end member allows shaft 124 to extend through the end member. Power may be removed from or delivered to shaft 124 depending on the mode of operation of rotary vane engine 100. The stator housing 102 is formed with a stator wall 126, or interior surface of stator housing 102. The stator wall 126 defines the interior space 128, or cavity, into which the rotor 118 is disposed.

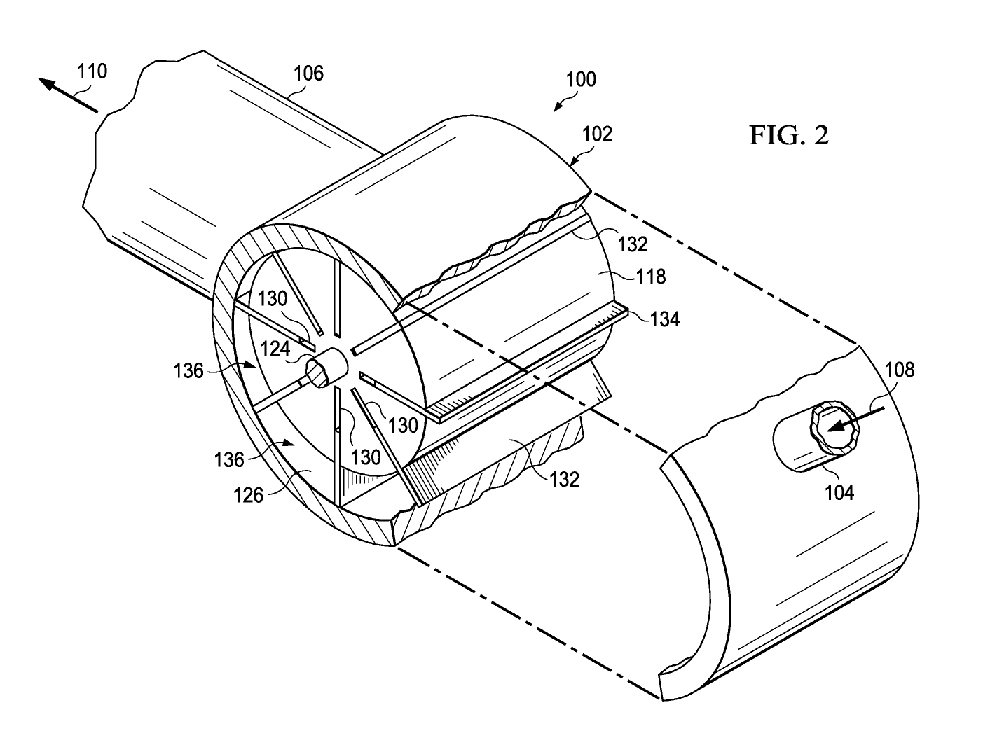

Referring now primarily to FIG. 2, the rotary vane engine 100 is shown with first insert member 112 removed and a portion of the stator housing 102 broken away. The rotor 118 is formed with a plurality of channels 130, or slots, into which a corresponding plurality of slideable vanes 132 are inserted. The slideable vanes 132 have distal ends 134. The slideable vanes 132 may be urged outward, or biased outward, by a mechanical device (e.g., a spring), other biasing means, or may be urged outward during operation by a resultant centrifugal force. In any event, the distal ends 134 of the slideable vanes 132 are caused to press against or otherwise engage the stator wall 126 such that a plurality of cells 136 are formed between adjacent slideable vanes 132. In the illustrative, non-limiting embodiment of FIGS. 1-2, the plurality of cells 136 is shown with eight cells formed, but it should be understood that any number of cells may be used depending on the desired performance characteristics.

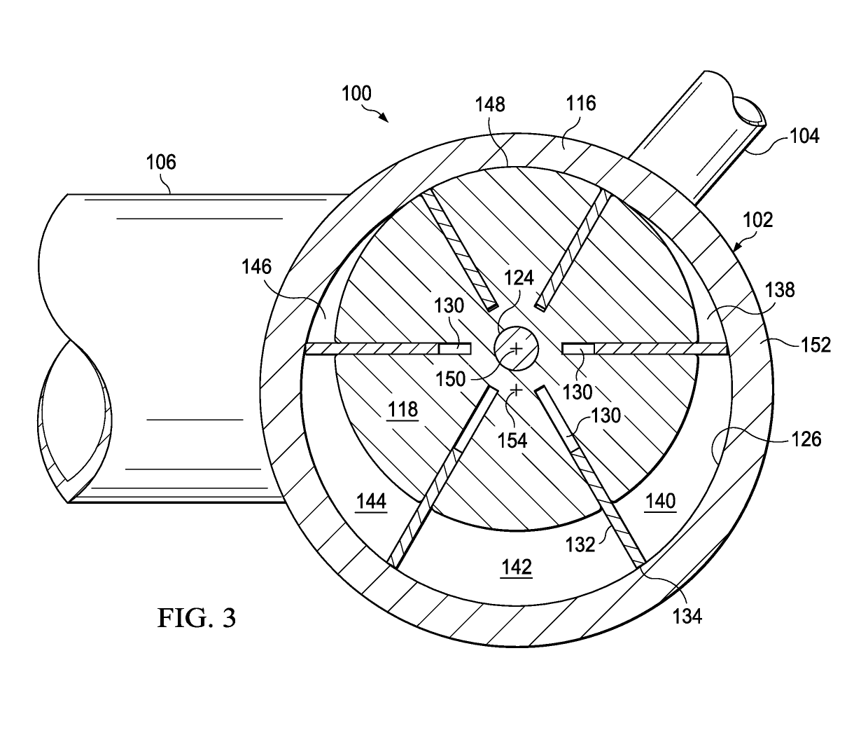

Referring now primarily to FIG. 3, a cross-section of the rotary vane engine 100 is presented with two modifications for presentation purposes: the number of cells has been adjusted to six and the first insert member 112 has been removed. The six cells are as follows: a first cell 138, a second cell 140, a third cell 142, a fourth cell 144, a fifth cell 146, and a sixth cell 148. As shown in this view, the shaft 124 has an axis of rotation 150, or central axis, and a second portion 152 of the stator housing 102 defines a stator housing axis 154. The stator housing axis 154 is the center point for the majority of the stator wall 126. The defined radius of the first portion 116 of the stator housing 102 is different from the second portion 152 as will now be described.

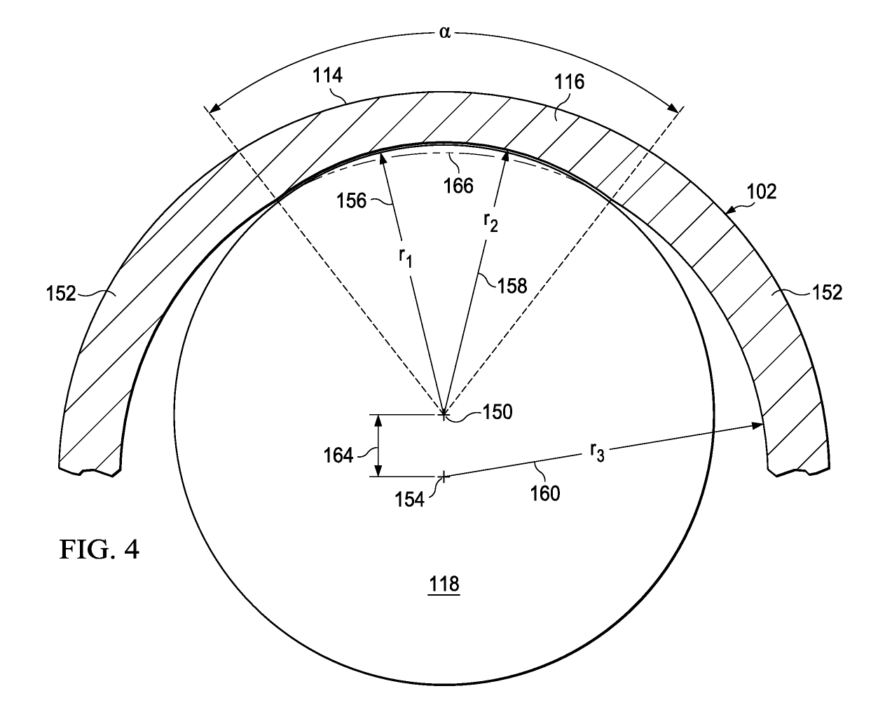

Referring now primarily to FIG. 4, a portion of the rotary vane engine 100 is presented. For convenience, the rotor 118 is shown without the plurality of channels 130 and the plurality of slideable vanes 132. In addition, only a portion of the second portion 152 of the stator housing 102 is presented. In this view, it can be seen that the rotor 118 has a first radius (r₁) 156. The first portion 116 of the stator housing 102 defines a second radius (r₂) 158. The second radius (r₂) 158 has focal point that is substantially the axis of rotation 150 of the rotor 118. Thus, the second radius (r₂) 158 goes from the axis of rotation 150 to the stator wall 126 at the first portion 116. In this way, the curvature of the stator wall 126 for the first portion 116 is the same or substantially the same as the curvature of the rotor 118 and thereby allows a nestled fit forming a long, tight seal over the sealing distance 114. The sealing distance 114 is defined over an angle α, which tracks the first portion 116. The sealing distance 114 shown in cross section represents a sealing area in the rotary vane engine 100 that avoids carry-back, or leakage. In some embodiments, the sealing distance 114 is equal to the distance between two adjacent slideable vanes 132. In some embodiments, the sealing distance 114 extends from the first port 104 to the second port 106 (see FIG. 1).

The second portion 152 of the stator housing 102, and in particular the stator wall 126 of the second portion 152, is defined by a third radius (r₃) 160. The third radius (r₃) 160 measures from the stator wall 126 of the second portion 152 to the stator housing axis 154. If the third radius (r₃) 160 were applied to the first portion 116 of the stator housing 102, the stator wall 126 in that region would be more inward as is shown by broken lines 166. The distance between the axis of rotation 150 and the stator housing axis 154 is given as distance 164 and may be used to express the eccentricity of the rotary vane engine 100. The typical measure of eccentricity is given by: eccentricity=(r₃−r₁)/r₃=1−(r₁/r₃).

Referring again primarily to FIG. 3, illustrative cycles of the rotary vane engine 100 without the first insert member 112 will be presented. When operating as a compressor (counter-clockwise rotation), the working fluid (gas or vapor) is aspired through the second port 106, then compressed in the cells 144, 142, 140. When the desired compression according to the configuration of the rotary vane engine 100 has been reached, the first cell 138 connects to the first port 104 and expels the compressed fluid completely.

When operated in an expansion mode (clockwise rotation), the rotary vane engine 100 aspirates the working fluid through the first port 104. The pressurized fluid (gas or vapor) flows through the first port 104 and into the first cell 138 which is just forming by clockwise rotation of the rotor 118. The first cell 138 is expanding and more pressurized fluid is aspired without throttling until the first cell 138 disconnects from the first port 104. The ongoing rotation of the rotor 118 further increases the cell volume to the position of the second cell 140, that of third cell 142, and finally to fourth cell 144 when the fourth cell 144 connects to the second port 106. The ongoing rotation of the rotor 118 then starts to decrease the cell volume of the fifth cell 146 and causes the expanded fluid to be expelled into the second port 106. The nestled location of the rotor 118 in the first portion 116 of the stator housing 102 helps to ensure that substantially all of the expanded fluid is removed before the cell 146 disconnects from the second port 106 and goes to the position of the sixth cell 148.

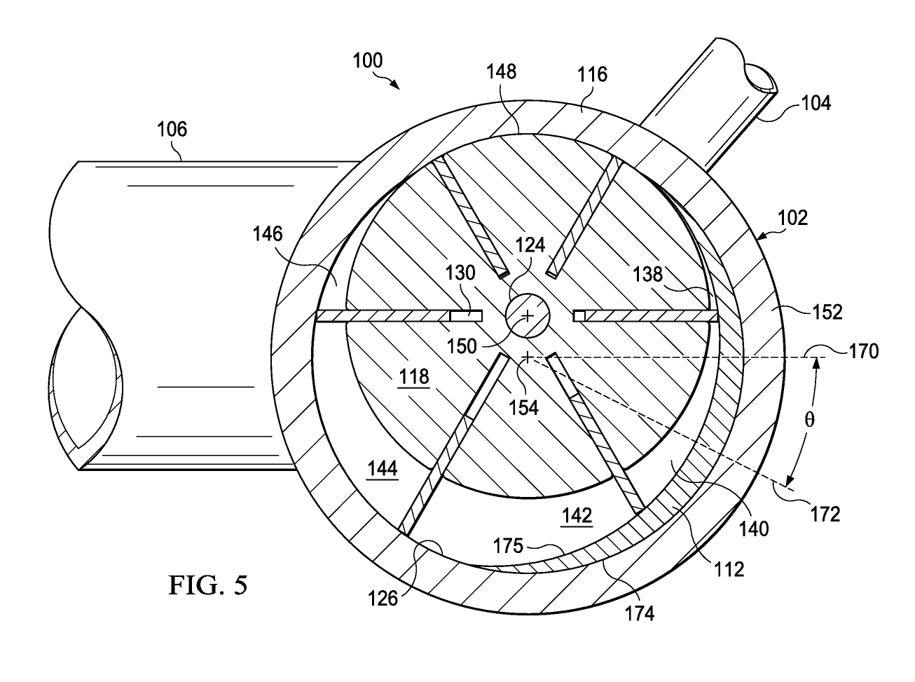

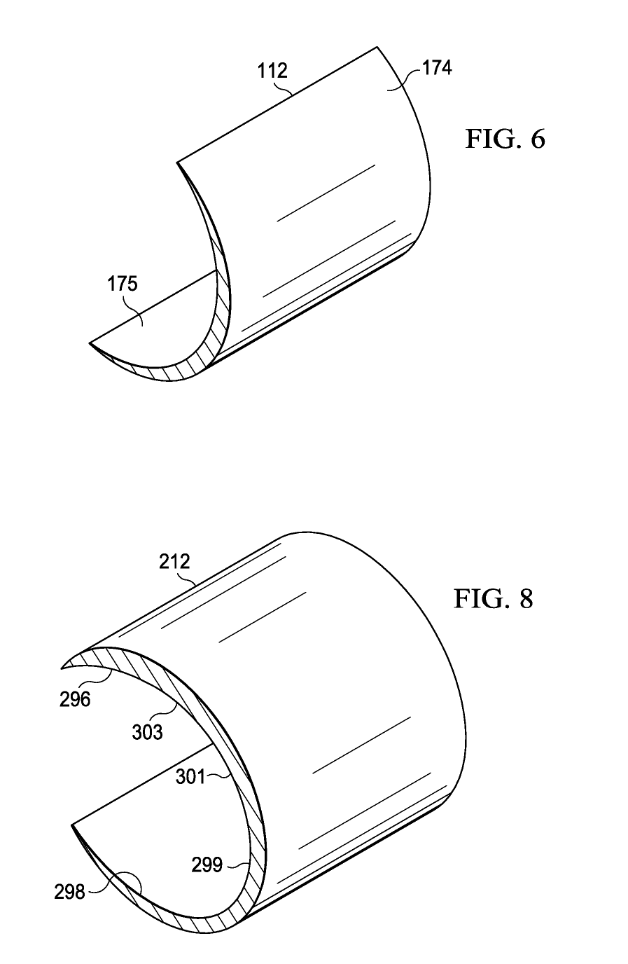

Referring now primarily to FIGS. 5 and 6, the first insert member 112 will be further described. The first insert member 112 may be fixed relative to the stator wall 126 or may be movable as will be described further below or may be formed as part of the stator wall 126. A first reference line 170, or datum, which is horizontal (for the orientation shown), is depicted. The first insert member 112 has a center point through which a second reference line 172 is depicted such that an angle β is formed between the first reference line 170 and the second reference line 172. Changes in angle β signify movement of the first insert member 112.

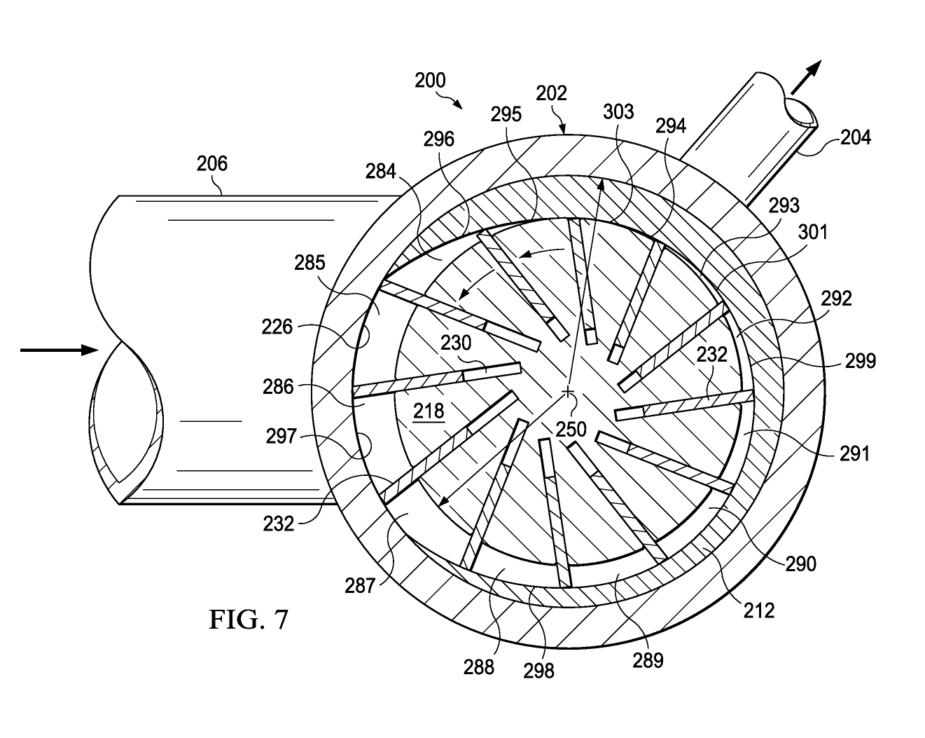

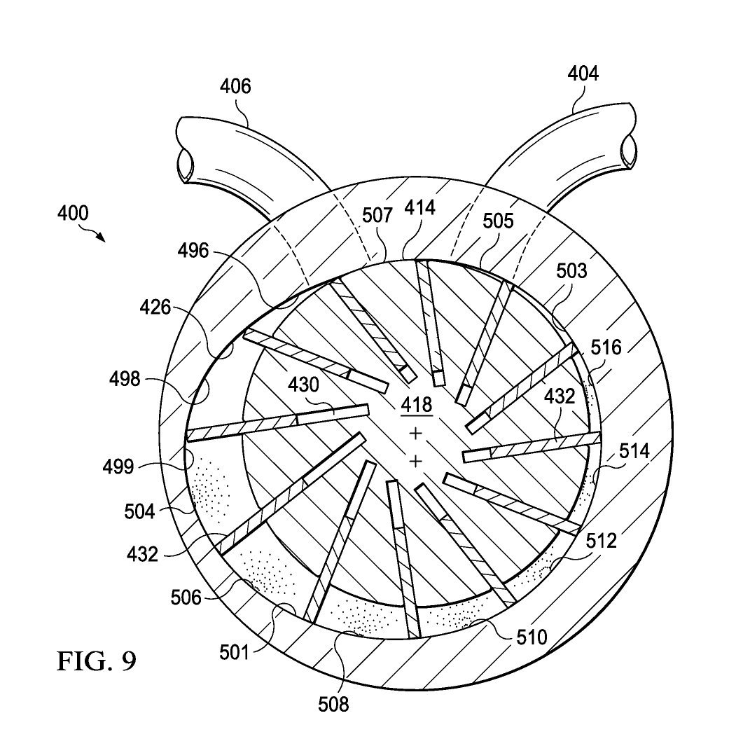

The first insert member 112 has an outboard surface 174 and an inboard surface 175. The outboard surface 174 has a curvature formed to substantially match that of the stator wall 126. The first insert member 112 allows for quick reduction of volume of the plurality of cells 136 passing the first insert member 112. Moreover, by varying the position of the first insert member 112, i.e., by varying angle β, a broad range of fluid manipulation ratios may be achieved for a given stator housing 102. In the illustrative, non-limiting embodiment presented, the first insert member 112 is separate from the stator housing 102 and the rotor 118 and has a crescent moon shape in cross-section. The first insert member 112 is inserted into the interior space 128 of the stator housing 102 and is moveable, i.e., angle β may be varied. Numerous other shapes may be used, e.g., an insert which causes substantially logarithmic decrease or increase of cell volume with rotation to cause a basically constant compression or expansion work per revolution as shown in FIG. 7. Thus, the insert may be used to provide a constant fluid manipulation ratio. By adapting the inner curve, i.e., the radius of the inboard surface 175, of the first insert member 112, nearly any course of compression or expansion may be achieved as a function of revolution angle. This allows the mapping of nearly every thermodynamic state change onto the behavior of the rotary vane engine 100. For example, as shown below in FIG. 9, expansion is usually a fast state change, while compression may be much slower when water is injected and vaporized. The vaporization is usually a slow process and consequently an insert with a short intake and a long compression improves the vaporization.

The outboard surface 174 of the first insert member 112 may have a curve radius that is the same or substantially the same as the radius of the stator wall 126 at least on the sliding area. The inboard surface 175 of the first insert member 112, and specifically the portion that actually effects the increased and decreased intake or final compression volume, may have a curve radius that is the same or substantially the same as the radius of the rotor 118. This radius of inboard surface 175 may have a curve radius that is between the radius (r₁) 156 of the rotor 118 and less than half of the sum (r₁+r₃) of the radius (r₁) 156 of the rotor 118 and the radius (r₃) 160 of the second portion 152 of the stator housing 102. The remaining surface area that fits to the stator wall 126 may have at least, over a major part of its surface, a significantly larger curved radius than the radius (r₁) 156 of the rotor 118. However, as this part will not be close to the rotor surface, the corresponding curve radius may be, in principle, any suitable value. The design of this portion of the first insert member 112 may ensure a smooth movement of the slideable vanes 132 in and out of the rotor 118.

In another illustrative, non-limiting embodiment, the first insert member 112 may be fixed to the rotor housing 102. In another alternative illustrative, non-limiting embodiment, instead of applying an independent insert, the first insert member 112 may actually be a portion of the stator wall 126 as a modified shape. In this alternative embodiment, the portion may be fixed or moveable. In still another alternative embodiment, a second insert member (not shown) may be added to provide the ability to adjust cell volumes in more locations. One insert may be attached, or one or both of the inserts may be moveable to adjust cell volume. Two independently moveable insert members may be used to allow the volume/mass flow and the fluid manipulation ratios to be independently adjusted. For example, an Otto engine may be built with two inserts within a rotary vane engine serving as a compressor to condition air for the Otto engine's intake.

Referring again primarily to FIG. 1, in instances in which the first insert member, e.g., the first insert member 112, is moveable, an adjustment device 176 may be used to move the first insert member 112 to either increase or decrease angle β. The adjustment device 176 may be as simple as a rod 178 extending through an opening 180 in the stator housing 102. The adjustment device 176 may also be a piston, hydraulic device, pneumatic device, servo, or other movement-causing device that moves the first insert member 112. In one embodiment, an actuator is coupled to the rod 178 to provide remote control of the first insert member 112. More generally, the actuator may be any device or combination of devices that allow for remote control of the position of the first insert member 112.

A plurality of transducers (not shown) may be deployed at various locations on the rotary vane engine 100 to obtain engine data. For example, the pressure at the first port 104 and second port 106 may be measured. The pressure in various cells may be measured. And numerous other data points may be taken. Moreover, in one embodiment, the transducers may provide signals to a controller. The controller, which includes a microprocessor, may work with an actuator to automatically adjust the adjustment device 176 in order to automatically regulate the performance of the rotary vane engine. For example, the controller may automatically change the fluid manipulation ratio during operation.

Referring now primarily to FIG. 5, a description of one illustrative expansion cycle (rotor 118 is moving clockwise) using the rotary vane engine 100 with the first insert member 112 will be presented. For analysis purposes, the cells 138, 140, 142, 144, 146, and 148 are treated as stationary, but in operation they are moving around the stator wall 126. In the beginning position, the sixth cell 148 may be regarded as having a volume of substantially zero. As the cell moves and is just connecting to the first port 104, working fluid enters and the cell volume starts to increase until the cell arrives at the position of the first cell 138, where it has a volume of 22 units (random units). The rotor 118 continues its clockwise rotation and the cell volume increases. As the moving cell disconnects from the first port 104, the cell has a cell volume of approximately 39 units. This means that the whole volume of the fluid taken in is 39 units. Up until now only an intake, or aspiration, has been performed, no expansion (or compression) of the working fluid has been carried out yet. Pressure and temperature of the fluid remain the same as in the first port 104, i.e. the initial values.

The curved radius of the inboard surface 175 of the first insert member 112 is approximately the same as the radius (r₁) of the rotor 118 at least for the portion of the first insert member 112 near the first port 104. Consequently, as rotation of the rotor 118 continues, the volume of the cell increases linearly or substantially linearly. As the moving cell reaches the position of the second cell, the volume has expanded to 215 units. As the rotor continues, the moving cell arrives at the position of the third cell 142 and has reached its maximum volume of 609 units. This means for this illustrative, non-limiting embodiment the rotary vane engine 100 has an expansion ratio, or manipulation ratio, of 609/39=15.6:1, and no dead volume is produced and, hence, no throttling occurs. As rotation continues, the moving cell connects to the second port 106.

With further rotation of the rotor 118, the moving cell reaches the position of the fourth cell 144 and reduces in volume to 409 units as the expanded fluid is smoothly moved out of the cell into the second port 106. As the moving cell reaches the position of the fifth cell 146, the volume is approximately 100 units. As the moving cell moves back to the sixth cell 148 position, substantially all the volume has been removed, e.g., the volume may be between 0 and 5.0 units in this embodiment. The cycle then starts again.

By moving the insert to various positions for angle β (e.g., β=1 degree, 2 degrees, 3 degrees, 4 degrees, 5 degrees, 6 degrees, 7 degrees, 8 degrees, 9 degrees, 10 degrees, 12 degrees, 14 degrees, 16 degrees, 18 degrees, 20 degrees, 22 degrees, etc., or any value in between) various performance characteristics may be achieved. In other words, the manipulation ratio may be changed. As an illustrative example, if the above cycle is repeated with β=4 degrees, then instead of 22 units being taken in as the moving cell is in the position of the first cell 138, only 9.3 units would be taken in. This means that only 42% (i.e., 9.3/22) of the fluid is aspired and the power of the rotary vane engine 100 is decreased. For β=5 degrees, only 26% of the initial volume at that same point is received. Going the other way, if β=negative 8 degrees (−8.0°), then the initial volume received at the same point is 57 units, or 259% of the initial case.

The significant range of intake volume at the position of the first cell 138 allows for power control of the rotary vane engine 100 over a very broad range. In the expansion, the rotary vane engine 100 may have the power controlled—separate from power regulation through a changed revolution number—from 10% or possibly less (lowest production=highest throttle) to 100% (maximum power production=no throttle), or which may deliver over-power in case of certain special circumstances when efficiency is not the most important aspect. For example, in case of a high power demand from a consumer for a limited period of time, the rotary vane engine 100 may produce twice the design point for optimized efficiency.

The rotary vane engine 100 with its alterable intake volume may have an expansive expansion ratio, for example, between 609/57=11:1 and 609/5.8=105:1 or more. In the case of condensable or vaporizable fluids being used as the working fluid, such a highly changeable expansion ratio may be advantageous in view of the quickly changing specific volumes with either source or condenser or both temperatures. When the operation of the rotary vane engine 100 involves two-phase expansion, a liquid (or substantially a liquid) enters through the first port 104 and is expanded as the rotor 118 rotates. As the moving cells expand with rotation, a high expansion ratio is desirable because the specific fluid volume in the liquid phase is small relative to the specific volume of the produced vapor—at least as long as the temperature is below the critical temperature of the working fluid. It should be noted that by inverting the revolution sense of the rotor 118, the described engine performs as a compressor with variable compression ratio or compression volume.

Referring now to FIG. 7, another illustrative, non-limiting embodiment of a rotary vane engine 200 is presented. The rotary vane engine 200 is analogous in most respects to the rotary vane engine 100 of FIGS. 1 through 6 and analogous parts are indicated by indexing the reference numerals by 100. The rotary vane engine 200 is shown functioning as a compressor and includes a first insert member 212. In this embodiment, the first insert member 212 is operable to provide a constant compression ratio.

The working fluid exits the first port 204 after the working fluid has entered the second port 206 and been compressed. The rotary vane engine 200 has a rotor 218 that rotates counter clockwise for a compression cycle as shown, but could be cycled as an expander. A first port 204 releases the compressed working fluid that was initially received at a second port 206. The rotary vane engine 200 includes a plurality of slideable vanes 232, which in this embodiment have been angled. The plurality of slideable vanes 232 form moving cells. In this illustrative, non-limiting embodiment, the rotary vane engine 200 includes twelve cells: first cell 284, second cell 285, third cell 286, fourth cell 287, fifth cell 288, sixth cell 289, seventh cell 290, eighth cell 291, ninth cell 292, tenth cell 293, eleventh cell 294, and twelfth cell 295.

To achieve a basically constant compression ratio versus revolution angle, the first insert member 212 is formed with particular characteristics. In this illustrative, non-limiting embodiment, the first insert member 212 has five portions: first portion 296, second portion 298, third portion 299, fourth portion 301, and fifth portion 303. The first insert member 212 has the first portion 296 with a large curved radius (larger than the radius r₃ of the stator wall 226) that corresponds to the beginning of aspiration, i.e. in the beginning of the intake when the slideable vanes 232 just start to protrude from the rotor 218. Then an open area 297 that allows the slideable vane 232 to interact with the stator wall 226. The other portions, 298, 299, 301, 303, of the first insert member 212 may have a curve radius considerably smaller than the curve radius of the stator wall 226. This arrangement causes the intake (aspiration) of the working fluid to be compressed in a short time, i.e. over a comparably small revolution angle.

At least the initial part of the first portion 296 is substantially tangent at the rotor 218. This means that the slideable vanes 232 are protruding at a maximum velocity using only the centrifugal force caused by the turning of the rotor 218. In some embodiments, the first portion 296 of the first insert 212 may open more quickly to create the first cell 284, and in some situations, the slideable vanes 232 may need more than centrifugal force to maintain contact with the first insert 212. In such a situation, the slideable vanes 232 may be urged outward or biased outward from the rotor 218 using a biasing device, such as springs, pneumatic devices, or other devices. The biasing device augments centrifugal force to maintain contact with the first insert 212 and stator wall.

At this stage of the rotation, no sealing must be effective in the second port 206, the centrifugal force may be exclusively used for moving the corresponding slideable vanes 232 out of the rotor 218. As previously noted, the slideable vanes 232 may be forced out more quickly by the biasing device, e.g., a spring or other mechanism (for example, compressed air) that augment the centrifugal force. In such an embodiment, the first portion 296 may form a positive angle with the tangent to the rotor 218. After intake has been carried out completely, i.e. the aspired working fluid is enclosed in the third cell 286, which faces the open area 297, compression starts.

To achieve a uniform compression process, the second portion 298 of the first insert member 212 has a progressively increasing curve radius. This ensures that the moving cell volume is quickly reduced and then the volume decreases more slowly. This arrangement results in a nearly constant compression ratio throughout the whole compression angle of the rotor's 218 revolution. A third portion 299 has a basically constant curve radius between the rotor's 218 curve radius and the stator wall 226. This third portion 299 moves the compressed working fluid further to the first port 204 without any major state change. The fourth portion 301 of the first insert member 212 may have a smaller curved radius still that causes the slideable vanes 232 to enter the rotor 218 and to settle into the rotor 218. The fifth portion 303 is a sealing portion that has a smaller radius—one that substantially matches the rotor 218 to form a seal. Consequently, the compressed working fluid is evenly expelled out of the first port 204.

As the moving cell goes through a revolution, the cells positions shown take on different volumes. In one illustrative, non-limiting embodiment, the cells may have the following units: first cell 284=85 units, second cell 285=198 units, third cell 286=216 units, fourth cell 287=147 units, fifth cell 288=99 units, sixth cell 289=66 units, seventh cell 290=48 units, eighth cell 291=33 units, ninth cell 292=27 units, tenth cell 293=16 units, eleventh cell 294=0 units, and twelfth cell 295=2.4 units. If the compression ratios are considered during the cycle for a few cells, one may see that the compression ratios are fairly constant at about 1.4. Consider for example, the third cell 286 with an initial volume 216 that exits the fluid to the next cell 287 that has a volume of 147, and thus the ratio (vi/ve) is 1.47. Then considering the seventh cell 290, the ratio (48/33) is 1.45.

It can be seen that the compression ratio over the whole compression angle is substantially constant. This may result in a constant power consumption, a constant rotary force of the rotor 218 and an even temperature and pressure increase of the working fluid, e.g., air, under compression.

If the consumed compression power should be reduced, or if—in case of a water injected compressors—steam should be added to the working fluid under compression, then cooling oil or water (or any other liquid) may be supplied or injected through the long compression path from the open area 297 to the third portion 299. This means that a significantly longer time is available for cooling or vaporization purposes. Consequently, the power consumption is reduced and the thermodynamic equilibrium (in case of vaporization) is better approached which may result in a higher efficiency. The rotary vane engine 200 may also be run counter clockwise as an expansion engine.

Referring now primarily to FIG. 9, another illustrative, non-limiting embodiment of a rotary vane engine 400 is presented. The rotary vane engine 400 is analogous in most respects to the rotary vane engine 100 of FIGS. 1 through 6 and analogous parts are indicated by indexing the reference numerals by 300. In the embodiment shown, the rotary vane engine 400 is shown functioning as a compressor. A stator wall 426 is shaped to function as an insert member that is operable to provide a desired effect.

A compressed working fluid exits the first port 404 after the working fluid has entered the second port 406 and been compressed. The rotary vane engine 400 has a rotor 418 that rotates counter clockwise for a compression cycle as shown, but could be cycled as an expander. The first port 404 delivers the compressed working fluid that was initially received by the second port 406 as a working fluid and an additional fluid, e.g., water and air, delivered through nozzles or injectors 504, 506, 508, 510, 512, 514, and 516. The rotor 418 is formed with a plurality of channels 430, or slots, into which a corresponding plurality of slideable vanes 432 are inserted. In this embodiment, the slots 430 have been angled. The plurality of slideable vanes 432 form moving cells. The moving cells receive fluid from the second port 406, increase in volume, and then decrease volume, and then deliver the compressed fluid to the first port 404.

In one illustrative, non-limiting embodiment, the rotary vane engine 400 aspires hot exhaust gas at 420° C. and 1 bar (ambient pressure) through the second port 406. No throttling occurs during this intake process. To facilitate the expansion of the hot exhaust gas to a sub-ambient pressure as quickly as possible, a nearly linear segment 496 of the stator wall 426, which is tangentially located to the rotor 418 is formed. A second segment 498 of the stator wall 426 progressively decreases the curve radius and connects to a basically circular segment 499. As the rotor 418 turns, the aspired hot exhaust gas is quickly expanded. In the illustrative example with a volume expansion ratio of four, the volume is quickly expanded such that the fluids arrive for discharge at a temperature of around 140° C. and a pressure around 150 mbar.

While the leading vane of the each moving cell is passing over the segment 499 in a sliding manner, the cell volume is basically constant. The nozzle 504, or injector, in that segment 499 injects water into the cell and the water quickly vaporizes. The vaporizing water lowers the temperature of the expanded exhaust gas further to around 70° C. and a pressure of 140 mbar. The moving cell then enters a segment 501 with a progressively decreasing curve radius that leads to a substantially constant compression ratio versus rotation angle. Additionally, nozzles 506-516 go on injecting water for vaporization. As this vaporization process consumes energy, the temperature of the fluid, which is now regarded as an exhaust gas/steam mixture, is limited to a value below the temperature of a pure adiabatic compression. In case of the illustrative example, at the end of compression, a temperature of around 80° C. is reached and the pressure equals ambient pressure of 1 bar so that the fluid can be discharged without any major pressure difference into the environment through the first port 404. For that purpose, the segment 503 is formed with a constant and somewhat larger curve radius than the rotor 418, and this helps transfers the fluid (re-compressed gas/steam mixture) to the first port 404. The segment 505 reduces the volume to zero to expel all the gas/steam into the first port 404. Afterwards, a sealing segment 507, which has a sealing distance 414, connects to the segment 505 with the second port 406 (or intake port), and a new cycle begins.

By mixing with ambient air after delivery to the first port 404, the gas/steam mixture may cool further and the steam may condense. If the ambient air is dry, then simple dilution of the steam occurs and no condensation takes place (which will not produce any difference for efficiency). Further cooling may also be carried out by a cooler external to the stator wall 426 cooler. It is also possible, that the working gas (exhaust gas in the above described example) may be re-delivered in whole or part to the second port 406 for closed circulation. In this case, the gas/steam mixture leaving the first port 404 would be cooled in an external cooler before the stream is returned to a heater (heat exchanger) for heating and then again to the second port 406 of the rotary vane engine 400. In such a case, the base pressure of the rotary vane engine 400, i.e. the pressure after expansion, may be a relatively higher value.

The illustrative, non-limiting embodiment of FIG. 9 allows, even at a fixed revolution speed, for control of the timing of certain state changes. The time may be extended or shortened according to the desired effect. In the described case, the vaporization in the course of re-compression is a much slower process than the expansion after aspiration and so a longer time is provided. This is reflected by the much larger rotation angle which is reserved for the re-compression process. The expansion takes place in less than 60° (⅙^{th} of one revolution) while the re-compression is assigned an angle of around 180° (half of one revolution), i.e. the re-compression process has three times more time than the expansion process.

Although the present invention and its advantages have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

We claim:

1. A rotary vane engine for compressing or expanding a working fluid, the rotary vane engine comprising:
a stator housing having a stator wall, the stator wall defining an interior space;
a rotor having a curvature, the rotor disposed within the interior space, the rotor having a plurality of slideable vanes operable to contact the stator wall;
wherein the stator wall has a first portion and a second portion, and wherein the first portion has a curvature that substantially matches the curvature of the rotor to form a sealing area between the rotor and stator housing having a sealing distance (d).

2. The rotary vane engine of claim 1, wherein the sealing distance (d) comprises at least 5% of a circumference of the stator wall.

3. The rotary vane engine of claim 1,
wherein rotor has a first radius (r₁); and
wherein the first portion of the stator wall has a second radius (r₂) and the second portion of the stator wall has a radius (r₃), and wherein the second radius (r₂) and the first radius (r₁) are at least substantially equal (r₁≈r₂), whereby the rotor forms the sealing area with the sealing distance (d).

4. A rotary vane engine comprising:
a stator housing having a stator wall, the stator wall defining an interior space;
a rotor having a curvature and disposed within the interior space, the rotor having a plurality of slideable vanes operable to contact the stator wall to form a plurality of cells; and
a first insert member disposed within the interior space and operable to adjust a fluid manipulation ratio of the rotary vane engine.

5. The rotary vane engine of claim 4, wherein the first insert member comprises a crescent-moon shaped insert.

6. The rotary vane engine of claim 4, wherein the first insert member comprises a constant-compression insert.

7. The rotary vane engine of claim 4, wherein the first insert member comprises a moveable portion of the stator housing.

8. The rotary vane engine of claim 4, further comprising a second insert member disposed within the interior space.

9. The rotary vane engine of claim 4 further comprising a second insert member disposed within the interior space, and wherein the first insert member and second insert member are moveable independently of one another.

10. The rotary vane engine of claim 4 further comprising an adjustment device coupled to the first insert member.

11. The rotary vane engine of claim 4, further comprising an adjustment device, wherein the adjustment device comprises a lever coupled to the first insert member and extending through an opening in the stator housing.

12. The rotary vane engine of claim 4, wherein the first insert member further comprises an adjustment device, and wherein the adjustment device comprises a lever extending through an opening in the stator housing and an actuator for selectively moving the lever.

13. The rotary vane engine of claim 4,
further comprising a plurality of transducers for measuring engine data and an adjustment device;
wherein the adjustment device comprises a lever extending through an opening in the stator housing, an actuator for selectively moving the lever, and a controller; and
wherein the controller is operable to receive the engine data and adjust the adjustment device to modify a fluid manipulation ratio.

14. The rotary vane engine of claim 4, wherein the stator wall has a first portion and a second portion, and wherein the first portion has a curvature that substantially matches the curvature of the rotor to form a sealing area between the rotor and stator housing having a sealing distance (d) in cross-section.

15. The rotary vane engine of claim 14, wherein the first insert member comprises a crescent-moon shaped insert.

16. The rotary vane engine of claim 14, wherein the first insert member comprises a portion of the stator housing.

17. The rotary vane engine of claim 14 further comprising an actuator associated with the crescent-moon shaped insert.

18. The rotary vane engine of claim 14 further comprising an adjustment device coupled to the first insert, wherein the adjustment device comprises a lever extending through an opening in the stator housing.

19. The rotary vane engine of claim 14, wherein the first insert member comprises an adjustment device coupled to the first insert, wherein the adjustment device comprises a lever extending through an opening in the stator housing and an actuator for selectively moving the lever.

20. The rotary vane engine of claim 14,
further comprising a plurality of transducers for measuring engine data;
wherein the first insert member comprises an adjustment device;
wherein the adjustment device comprises a lever extending through an opening in the stator housing, an actuator for selectively moving the lever, and a controller; and
wherein the controller is operable to receive the engine data and adjust the adjustment device to modify the fluid manipulation ratio.

21. A method of manufacturing a rotary vane engine, the method comprising the steps of:
forming a stator housing having a stator wall, the stator wall defining an interior space;
forming a rotor having a curvature, the rotor for disposing within the interior space, the rotor having a plurality of slideable vanes operable to contact the stator wall;
disposing the rotor within the stator housing;
wherein the interior space of the stator housing has a first portion and a second portion; and
wherein the step of forming the stator housing comprises forming the stator housing with a first portion that has a curvature that at least substantially matches the curvature of the rotor to form a sealing area between the rotor and stator housing having a sealing distance (d).

22. The method of manufacturing a rotary vane engine of claim 21, wherein the sealing distance (d) comprises 5% of a circumference of the stator wall.

23. The method of manufacturing a rotary vane engine of claim 21,
wherein rotor has a first radius (r₁); and
wherein the first portion of the interior space has a second radius (r₂) and the second portion of the interior space has a radius (r₃), and wherein the second radius (r₂) and the first radius (r₁) are substantially equal (r₁≈r₂), whereby the rotor forms the sealing area with the sealing distance (d).

24. A method of manufacturing a rotary vane engine comprising:
forming a stator housing having a stator wall, the stator wall defining an interior space;
forming a rotor having a curvature, the rotor for disposing within the interior space, the rotor having a plurality of slideable vanes operable to contact the stator wall to form a plurality of cells;
disposing the rotor within the stator housing;
forming a first insert member; and
disposing the first insert member within the interior space, wherein the insert member is operable to adjust a fluid manipulation ratio of the rotary vane engine.

25. The method of manufacturing a rotary vane engine of claim 24, wherein the step of forming a first insert member comprises forming a crescent-moon shaped insert.

26. The method of manufacturing a rotary vane engine of claim 24, wherein the step of forming a first insert member comprises forming the stator housing to include a moveable portion.

27. The method of manufacturing a rotary vane engine of claim 24, wherein the first insert member comprises an adjustment device.

28. The method of manufacturing a rotary vane engine of claim 24 further comprising the steps of: forming an adjustment device, placing the adjustment device into the interior space; wherein the adjustment device comprises a lever; and wherein the lever is placed through an opening in the stator housing.

29. The method of manufacturing a rotary vane engine of claim 28 further comprising the step of: placing an actuator in communication with the lever to selectively move the lever.

30. The method of manufacturing a rotary vane engine of claim 27 further comprising the steps of:
providing a plurality of transducers for measuring engine data; and
adjusting the adjustment device with a controller to modify the fluid manipulation ratio, wherein the controller receives engine data from the plurality of transducers.

31. The method of manufacturing a rotary vane engine of claim 24, wherein the interior space of the stator housing has a first portion and a second portion, and wherein the step of forming the stator housing comprises forming the stator housing with the first portion having a curvature that substantially matches the curvature of the rotor whereby a sealing area is formed between the rotor and stator housing.

32. The method of manufacturing a rotary vane engine of claim 31, wherein the step of forming a first insert member comprises forming a crescent-moon shaped insert.

33. The method of manufacturing a rotary vane engine of claim 31, wherein the step of forming the first insert member comprises a forming the stator housing to have a moveable portion.

34. The method of manufacturing a rotary vane engine of claim 31, wherein the first insert member comprises a control mechanism.

35. The method of manufacturing a rotary vane engine of claim 31, wherein the first insert member comprises a control mechanism, and wherein the control mechanism comprises a lever extending through an opening in the stator housing.

36. The method of manufacturing a rotary vane engine of claim 31, wherein the first insert member comprises an adjustment device coupled to the first insert, wherein the adjustment device comprises a lever extending through an opening in the stator housing and an actuator for selectively moving the lever.

37. The method of manufacturing a rotary vane engine of claim 31,
further comprising the step of providing a plurality of transducers for measuring engine data;
wherein the first insert member comprises a adjustment device;
wherein the adjustment device comprises a lever extending through an opening in the stator housing, an actuator for selectively moving the lever, and a controller; and
wherein the controller is operable to receive the engine data from the plurality of transducers and adjust the adjustment device to modify the fluid manipulation ratio.

38. The method of manufacturing a rotary vane engine of claim 31, wherein the step of forming the first insert member comprises forming an insert member that is operable to provide a substantially uniform fluid manipulation ratio around a stator wall.

39. A method of expanding a compressed working fluid in a rotary vane engine, the method comprising:
receiving the compressed working fluid in a moving cell formed in an interior space of the rotary vane engine, wherein the movable cell is formed between a stator wall, a rotor, and two slideable vanes on the rotor;
moving the moving cell such that the moving cell has a larger volume; and
forming at least a substantial fluid seal between the rotor and stator wall over a sealing distance.

40. The method of claim 39, wherein the sealing distance is at least one percent (1%) of an internal circumference of the stator wall.

41. The method of claim 39, wherein the sealing distance is at least four percent (4%) of an internal circumference of the stator wall.

42. The method of claim 39, further comprising using a first insert member in the interior space of the rotary vane engine to modify a fluid manipulation ratio.
